(19) United States
(12) Patent Application Publication
(10) Pub. No.: US 2019/0343080 A1
(43) Pub. Date: Nov. 14, 2019

(54) 1-SHOT PET PADS SYSTEM AND METHOD

(71) Applicants: Ludwig Chapman, Bronx, NY (US); Manuel Caraballo, Bronx, NY (US); Jason Rosado, Bronx, NY (US); Anthony Porfidia, Bronx, NY (US); Ryan Sanabria, Brewster, NY (US)

(72) Inventors: Ludwig Chapman, Bronx, NY (US); Manuel Caraballo, Bronx, NY (US); Jason Rosado, Bronx, NY (US); Anthony Porfidia, Bronx, NY (US); Ryan Sanabria, Brewster, NY (US)

(21) Appl. No.: 16/391,289

(22) Filed: Apr. 22, 2019

Related U.S. Application Data
(60) Provisional application No. 62/632,520, filed on Feb. 20, 2018.

(51) Int. Cl. A01K 23/00; A01K 1/015; E01H 1/12

(52) U.S. Cl. CPC A01K 23/005; E01H 1/1206; A01K 1/0157

(57) ABSTRACT

The device is designed to ease the process of picking up pet waste. It offers a more convenient method for collecting waste comprised of a square absorbent pad. The device includes drawstrings at two ends that make it easier and more sanitary to pick up and dispose of the pet's waste. It affords stronger, more durable, and more absorbent pads than existing products. The device effectively eliminates the need for pet owners to pick up pet waste using their hands.

### CROSS-REFERENCE TO RELATED APPLICATION(S)

The present application is related to and claims priority to U.S. Provisional Patent Application No. 62/632,520 filed Feb. 20, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pet accessories of existing art and more specifically relates to pet pads.

### RELATED ART

Many people in modern society have pets. Many pet owners utilize absorbent pads to collect pet waste when house training a dog or when going outside is not an option. Existing pads are inefficient. To remove the pet waste using conventional means, pet owners are required to either touch the waste with their hands while lifting it from the pad or use some type of tool to scoop the waste into another receptacle. This process is messy and time consuming. In addition, some pads are weak and will leak through, which defeats the purpose of having a pad in place to begin with. A suitable solution is desired.

U.S. Pat. No. 8,960,127 to Martin Miller relates to a waste pad. The described pet waste collection apparatus has a drawstring within an outer peripheral border of the pet waste collection apparatus, the drawstring having a drawstring exit portion exiting the pet waste collection apparatus, the drawstring exit portion of the drawstring releasably fastened to a bottom corner portion of the pet waste collection apparatus, the pet waste collection apparatus adapted to form a shape of a bag when the drawstring exit portion of the drawstring is released from the bottom corner portion of the pet waste collection apparatus and the drawstring is pulled taut, the pet waste collection apparatus substantially enclosing and sealing pet waste within the pet waste collection apparatus when the drawstring is pulled taut. Alternative embodiments include a bifurcated exit sleeve, an alternate exit sleeve, and a tab, each adapted to adhesively and releasably fasten the drawstring exit portion to the bottom corner, and a leak protection barrier.

### SUMMARY OF THE INVENTION

In view of the foregoing disadvantages inherent in the known pet accessories art, the present disclosure provides a novel pet pad system, entitled, “1-Shot Pet Pads”. The general purpose of the present disclosure, which will be described subsequently in greater detail, is to provide an efficient and effective pet pad system.

A pet pad system is disclosed herein comprising: a pet pad having a pad-body defined by a periphery; an inner-volume; an absorbent-side; a fluid-resistant-side; and at least one drawstring; wherein the inner-volume of the pad-body contains the absorbent-side and the fluid-resistant-side, relationally-speaking the absorbent-side and the fluid-resistant-side opposing each other, the absorbent-side to be facing upwardly when used such that a pet is able to relieve themselves on the pad-body, the pet pad able to be removed when used via manipulating the at least one drawstring about the periphery to enclose the inner-volume with pet waste contained therein in a gathered-condition.

A method of use for the pet pad system is also disclosed herein, the method comprising the steps of: providing pet pad system comprising a pet pad having a pad-body defined by a periphery; an inner-volume; an absorbent-side; a fluid-resistant-side; and a drawstring; using the pet pad by a pet; manipulating the drawstring to effectively enclose the pet pad and waste left by the pet; and discarding the pet pad. The discarding step may be done in an environmentally-friendly fashion.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a 1-shot pet pad, constructed and operative according to the teachings of the present disclosure.

FIG. 1 is a perspective view of the 1-shot pet pad during an ‘in-use’ condition, according to an embodiment of the disclosure.

FIG. 2 is a perspective view of the 1-shot pet pad of FIG. 1, according to an embodiment of the present disclosure.

FIG. 3 is a perspective view of the 1-shot pet pad of FIG. 1, according to an embodiment of the present disclosure.

FIG. 4 is a perspective view of the 1-shot pet pad of FIG. 1, according to an embodiment of the present disclosure.

FIG. 5 is a flow diagram illustrating a method of use for the 1-shot pet pad, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pet accessory and more particularly to a 1-shot pet pad system as used to improve the ease of removing pet waste.

Generally, Shot Pet Pads provides an absorbent pad designed for collecting pet waste. The invention is comprised of a composite piece of material with an absorbent side and a fluid-resistant side. The material may have drawstrings inside a cavity formed around the perimeter of the material. The material is disposed on the ground with the absorbent side facing up to receive pet waste, Drawstrings are used to encapsulate the waste in the material for disposal. The pad itself may be square, rectangular, or circular in shape (other shapes may be used). The rectangular version works just like the circular product, but the kitty litter is able to be put on top of the pad and when it's ready to be thrown away you would pull the drawstring and discard it.

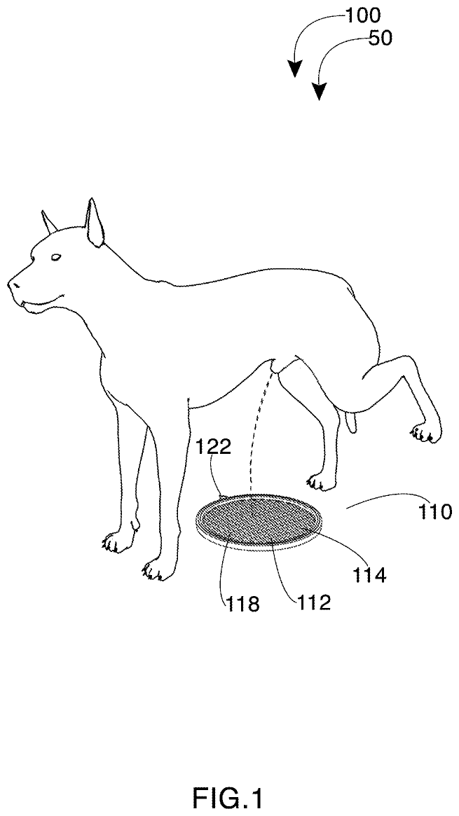

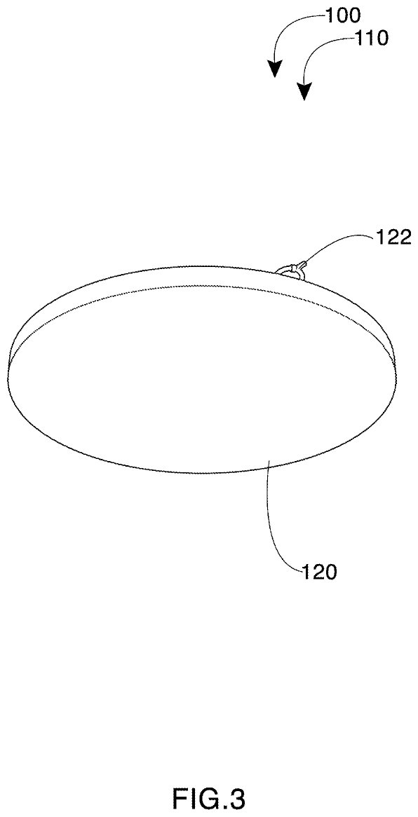

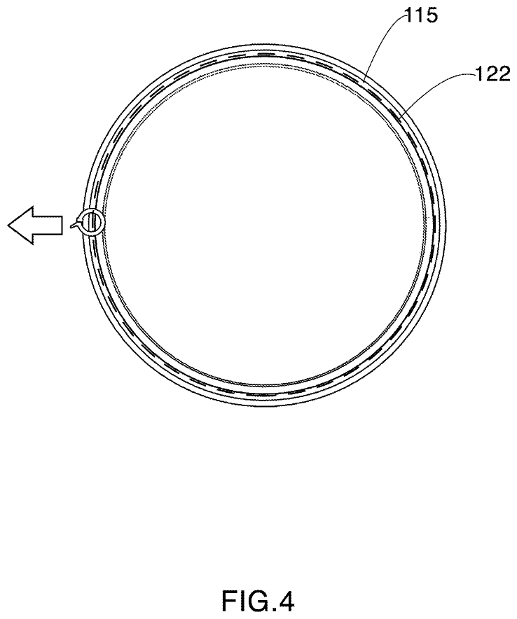

Referring now more specifically to the drawings by numerals of reference, there is shown in FIGS. 1-4, various views of a pet pad system 100.

FIG. 1 shows a pet pad system 100 during an ‘in-use’ condition 50, according to an embodiment of the present disclosure. Here, the pet pad system 100 may be beneficial for use by a user to provide a means to discard of pet waste in an efficient and non-messy manner. As illustrated, the pet pad system 100 may include: a pet pad 110 having a pad-body 112 (defined by a periphery 114; an inner-volume 116; an absorbent-side 118; a fluid-resistant-side 120; and at least one drawstring 122); wherein the inner-volume 116 of the pad-body 112 contains the absorbent-side 118 and the fluid-resistant-side 120. Relationally-speaking the absorbent-side 118 and the fluid-resistant-side 120 oppose each other. The absorbent-side 118 to be facing upwardly when used such that a pet is able to relieve themselves on the pad-body 112, the fluid-resistant-side 120 is located adjacent the floor or ground surface when used. The pet pad 110 is able to be removed when used via manipulating the at least one drawstring 122 about the periphery 114 to effectively enclose the inner-volume 116 with pet waste contained therein in a gathered-condition (similar to how a garbage bag functions).

According to one embodiment, the pet pad system 100 may be arranged as a kit. In particular, the pet pad system 100 may further include a set of instructions. The instructions may detail functional relationships in relation to the structure of the pet pad system 100 such that the pet pad system 100 can be used, maintained, or the like, in a preferred manner.

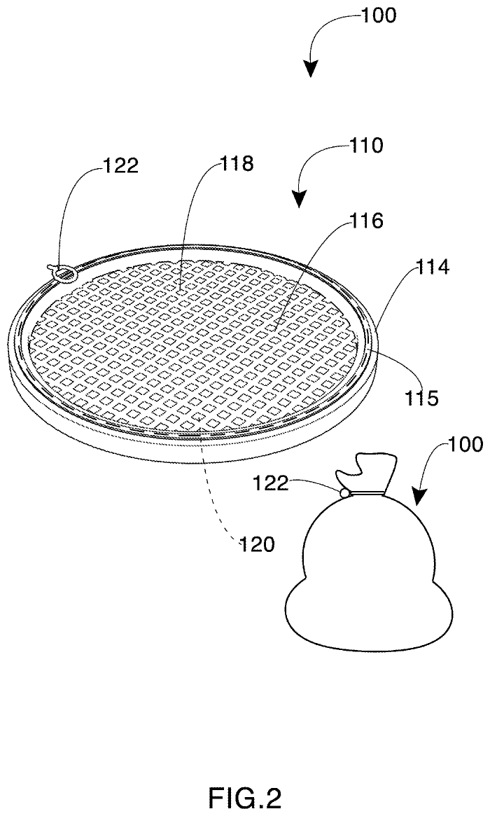

FIGS. 2-4 show various views of the present invention pet pad system 100. The absorbent-side 118 preferably comprises composite material. The absorbent-side 118 may comprise sodium polyacrylate or other suitable absorbing means. The pad-body 112 is preferably circular such that is can be easily manipulated and alternately pad-body 112 may be non-circular. In certain embodiments of the pet pad system 100 the pad-body 112 is square or rectangular or are shaped in different shapes and sizes. The periphery 114 comprises a channel 115; wherein the channel 115 substantially covers the at least one drawstring 122. The at least one drawstring 122 (preferably one) comprises a closed loop.

The absorbent-side 118 comprises wicking means that effectively absorbs urine and the fluid-resistant-side 120 provides a barrier; wherein the barrier preferably comprises plastic or other suitably equivalent material. The pad-body 112 is preferably planar (planar disk) and is flexible. The pet pad 110 when gathered by the drawstring 122 forms a bag in the gathered-condition (very similar to that of a garbage bag).

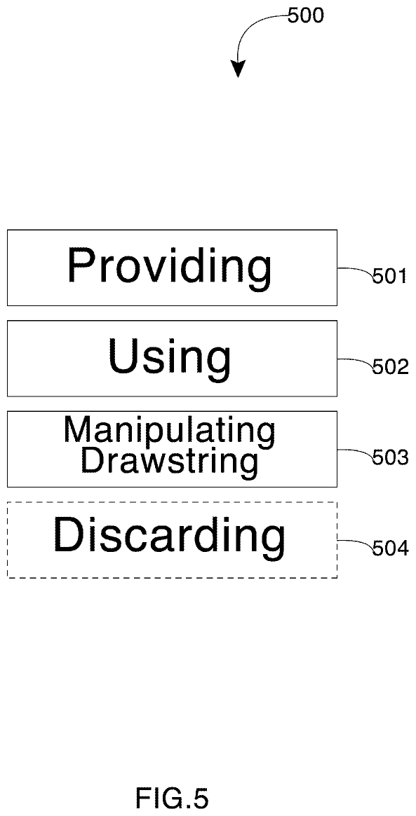

FIG. 5 is a flow diagram illustrating a method of use 500 for the pet pad system 100, according to an embodiment of the present disclosure. In particular, the method of use 500 for the pet pad system 100 may include one or more components or features of the pet pad system 100 as described above. As illustrated, the method of use 500 may include the steps of: step one 501, providing the above-mentioned pet pad system 100; step two 502, using the pet pad by a pet; step three 503, manipulating the drawstring to effectively enclose the pet pad and waste left by the pet; and step four 504 discarding the pet pad. The discarding step may be done in an environmentally-friendly fashion.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet pad system comprising:
a pet pad having
a pad-body defined by
a periphery;
an inner-volume;
an absorbent-side;
a fluid-resistant-side; and
at least one drawstring;
wherein said inner-volume of said pad-body contains said absorbent-side and said fluid-resistant-side, said absorbent-side and said fluid-resistant-side opposing each other, said absorbent-side to be facing upwardly when used such that a pet is able to relieve themselves on said pad-body, said pet pad able to be removed when used via manipulating said at least one drawstring about said periphery to enclose said inner-volume with pet waste contained therein in a gathered-condition.

2. The pet pad system of claim 1, wherein said absorbent-side comprises composite material.

3. The pet pad system of claim 1, wherein said pad-body is circular.

4. The pet pad system of claim 1, wherein said pad-body is non-circular.

5. The pet pad system of claim 1, wherein the periphery comprises a channel.

6. The pet pad system of claim 5, wherein the channel substantially covers said at least one drawstring.

7. The pet pad system of claim 1, wherein said absorbent-side comprises wicking means.

8. The pet pad system of claim 1, wherein the fluid-resistant-side provides a barrier.

9. The pet pad system of claim 8, wherein the barrier comprises plastic.

10. The pet pad system of claim 1, wherein the at least one drawstring comprises a closed loop.

11. The pet pad system of claim 1, wherein said pad-body is square.

12. The pet pad system of claim 1, wherein the pad-body is rectangular.

13. The pet pad system of claim 2, wherein the pad-body is planar.

14. The pet pad system of claim 13, wherein the pad-body is flexible.

15. The pet pad system of claim 14, wherein the pet pad when gathered by said drawstring forms a bag in said gathered-condition.

16. The pet pad system of claim 1, wherein the absorbent-side comprises sodium polyacrylate.

17. A pet pad system comprising:
a pet pad having
a pad-body defined by
a periphery;
an inner-volume;
an absorbent-side;
a fluid-resistant-side; and
a drawstring;
wherein said inner-volume of said pad-body contains said absorbent-side and said fluid-resistant-side, said absorbent-side and said fluid-resistant-side opposing each other, said absorbent-side to be facing upwardly when used such that a pet is able to relieve themselves on said pad-body, said pet pad able to be removed when used via manipulating said at least one drawstring about said periphery to enclose said inner-volume with pet waste contained therein in a gathered-condition;
wherein said absorbent-side comprises composite material, said composite material comprising sodium polyacrylate;
wherein said absorbent-side comprises wicking means;
wherein the pad-body is planar;
wherein the pad-body is flexible;
wherein said pad-body is circular;
wherein the periphery comprises a channel;
wherein the channel substantially covers said drawstring;
wherein the drawstring comprises a closed loop;
wherein the fluid-resistant-side provides a barrier;
wherein the barrier comprises plastic; and
wherein the pet pad when gathered by said drawstring forms a bag in said gathered-condition.

18. The pet pad system of claim 17, further comprising set of instructions; and
wherein the pet pad system is arranged as a kit.

19. A method of use for a pet pad system, the method comprising the steps of:
providing pet pad system comprising a pet pad having a pad-body defined by a periphery; an inner-volume; an absorbent-side; a fluid-resistant-side; and a drawstring;
using the pet pad by a pet;
manipulating said drawstring to effectively enclose said pet pad and waste left by said pet; and
discarding said pet pad.

20. The method of claim 19, wherein said discarding is done in an environmentally-friendly fashion.
